(19) United States
(12) Patent Application Publication
(10) Pub. No.: US 2022/0039118 A1
(43) Pub. Date: Feb. 3, 2022

(54) SIDELINK DATA TRANSMISSION METHOD, DEVICE AND STORAGE MEDIUM

(71) Applicant: GUANGDONG OPPO MOBILE TELECOMMUNICATIONS CORP., LTD., Dongguan (CN)

(72) Inventors: Zhenshan ZHAO, Dongguan (CN); Qianxi LU, Dongguan (CN); Huei-Ming LIN, South Yarra (AU)

(73) Assignee: GUANGDONG OPPO MOBILE TELECOMMUNICATIONS CORP., LTD., Dongguan (CN)

(21) Appl. No.: 17/501,724

(22) Filed: Oct. 14, 2021

Related U.S. Application Data
(63) Continuation of application No. PCT/CN2019/082769, filed on Apr. 15, 2019.

(51) Int. Cl. H04W 72/12; H04W 72/04; H04L 27/26

(52) U.S. Cl. CPC H04W 72/1263; H04W 72/0446; H04L 27/2607; H04L 27/26025; H04W 72/0453

(57) ABSTRACT

Embodiments of the present application provide a sidelink data transmission method, a device and a storage medium. When a terminal device transmits sidelink data on either sidelink of a first sidelink and a second sidelink, the sidelink data on the other sidelink is also transmitted by the terminal device at the same time, and/or when the terminal device does not transmit the sidelink data on either sidelink of the first sidelink and the second sidelink, the sidelink data on the other sidelink is not transmitted by the terminal device either. In this way, total power of the terminal device is evenly distributed on the first sidelink and the second sidelink as much as possible, and a dynamic change of transmission power on the first sidelink and the second sidelink is reduced or avoided.

### CROSS-REFERENCE TO RELATED APPLICATIONS

This application is a continuation of International Application No. PCT/CN2019/082769 filed on Apr. 15, 2019, the content of which is incorporated herein by reference in its entirety.

### TECHNICAL FIELD

Embodiments of the present application relate to communication technologies and, in particular, to a sidelink data transmission method, a device and a storage medium.

### BACKGROUND

Internet of vehicles is a sidelink (SL) transmission technology based on device to device (D2D). Different from a traditional long term evolution (LTE) system in which communication data is received or transmitted through a base station, the internet of vehicles adopts device to device direct communication.

With a development of the mobile communication technology, a resource used for sidelink transmission in a current Internet of vehicles system can be a transmission resource in an LTE system or a new radio (NR) system. In prior art, a sidelink of the LTE system and a sidelink of the NR system coexist in the Internet of vehicles system. Specifically, the sidelink of the LTE system and the sidelink of the NR system can carry out frequency division multiplexing, that is to say, a same terminal device can simultaneously transmit data on the sidelink of the LTE system and data on the sidelink of the NR system on different carriers.

However, when a terminal device simultaneously transmits the data on the sidelink of LTE system and the data on the sidelink of NR system on different carriers, total transmission power of the terminal device may be shared by the sidelink of LTE system and the sidelink of NR system, since time durations for transmitting data on the sidelink of LTE system and the sidelink of NR system by the terminal device are different, the transmission power of the terminal device on the sidelink of LTE system and the transmission power of the terminal device on the sidelink of NR system need to be dynamically adjusted, resulting in that a receiving terminal corresponding to the terminal device needs to carry out automatic gain control (AGC) frequently, which reduces the performance of the receiving terminal.

### SUMMARY

Embodiments of the present application provide a sidelink data transmission method, a device and a storage medium, so that when a first sidelink in a first communication system and a second sidelink in a second communication system coexist in an Internet of vehicles system, a dynamic change of transmission power on the two different sidelinks can be reduced or avoided.

A first aspect, an embodiment of the present application can provide a sidelink data transmission method, including:

determining, by a terminal device, N slots of a first sidelink according to a subcarrier spacing of the first sidelink, where N is greater than or equal to 2, a time domain length of the N slots of the first sidelink is as same as a time domain length of one subframe of a second sidelink, the second sidelink is a sidelink in a first communication system, and the second sidelink is a sidelink in a second communication system; and

transmitting, by the terminal device, first sidelink data on the first sidelink and second sidelink data within a time duration corresponding to a time domain symbol that is used to transmit the second sidelink data on the second sidelink within a subframe of the second sidelink; and/or, not transmitting, by the terminal device, the first sidelink data and the second sidelink data within a time duration corresponding to a time domain symbol that is not used to transmit the second sidelink data within the subframe.

A second aspect, an embodiment of the present application can provide a terminal device, including:

a determining module, configured to determine N slots of a first sidelink according to a subcarrier spacing of the first sidelink, where N is greater than or equal to 2, a time domain length of the N slots of the first sidelink is as same as a time domain length of one subframe of a second sidelink, the second sidelink is a sidelink in a first communication system, and the second sidelink is a sidelink in a second communication system; and

a transmitting module, configured to transmit first sidelink data on the first sidelink and second sidelink data within a time duration corresponding to a time domain symbol that is used to transmit the second sidelink data on the second sidelink within a subframe of the second sidelink; and/or, not transmit, by the terminal device, the first sidelink data and the second sidelink data within a time duration corresponding to a time domain symbol that is not used to transmit the second sidelink data within the subframe.

A third aspect, an embodiment of the present application can provide a terminal device, including:

a processor, a memory and an interface communicating with a network device or other terminal devices;

the memory stores computer execution instructions;

the processor executes the computer execution instructions stored in the memory, causing the processor to execute the sidelink data transmission method as described in the first aspect.

A fourth aspect, an embodiment of the present application provides a computer-readable storage medium, where the computer-readable storage medium stores computer execution instructions, which, when executed by the processor, are used to implement the sidelink data transmission method as described in the first aspect.

A fifth aspect, an embodiment of the present application provides a program, which, when executed by a processor, is used to execute the side data transmission method as described in the first aspect.

In an embodiment, the above-mentioned processor may be a chip.

A sixth aspect, an embodiment of the present application provides a computer program product, including a program instruction which is used to implement the sidelink data transmission method as described in the first aspect.

A seventh aspect, an embodiment of the present application provides a chip, including a processing module and a communication interface, the processing module can execute the sidelink data transmission method as described in the first aspect.

Furthermore, the chip further includes a storing module (e.g., a memory) for storing an instruction, and the processing module is configured to execute the instruction stored in the storing module, and execution of the instruction stored in the storing module causes the processing module to execute the sidelink data transmission method as described in the first aspect.

In the sidelink data transmission method, device and storage medium provided by the embodiment, a terminal device determines N slots of a first sidelink according to a subcarrier spacing of the first sidelink, so that a time domain length of the N slots of the first sidelink is as same as a time domain length of one subframe of a second sidelink, when a certain time domain symbol within one subframe of the second sidelink is used to transmit second sidelink data on the second sidelink, the terminal device transmits the first sidelink data on the first sidelink and second sidelink data within a time duration corresponding to the time domain symbol, and/or, when a certain time domain symbol within one subframe of the second sidelink is not used to transmit the second sidelink data, the terminal device determines not to transmit the second sidelink data and the first sidelink data within the time duration corresponding to the time domain symbol, that is to say, when the terminal device transmits the sidelink data on either sidelink of the first sidelink and the second sidelink, the sidelink data on the other sidelink is also transmitted by the terminal device at the same time, and/or when the terminal device does not transmit the sidelink data on either sidelink of the first sidelink and the second sidelink, the sidelink data on the other sidelink is not transmitted by the terminal device either, thereby refraining the terminal device from transmitting the sidelink data on the other sidelink when transmitting the sidelink data on either sidelink of the two different sidelinks to the greatest extent, so that total power of the terminal device is evenly distributed on the first sidelink and the second sidelink as much as possible, and a dynamic change of transmission power on the first sidelink and the second sidelink is reduced or avoided. At the same time, the number of automatic gain controls at a receiving terminal is also reduced effectively, and the automatic gain control at the receiving terminal is even avoided, thereby improving the performance of the receiving terminal.

### BRIEF DESCRIPTION OF DRAWINGS

In order to describe technical solutions in the embodiments of the present application or in the prior art clearer, the following will briefly introduce accompanying drawings that need to be used in the description of the embodiments or the prior art. Apparently, the following accompanying drawings are some embodiments of the present application. For persons of ordinary skill in the art, other accompanying drawings can be obtained according to these accompanying drawings without paying creative effort.

FIG. 1 is a schematic diagram of a communication system according to the present application;

FIG. 2 is a flow chart of a sidelink data transmission method according to the present application;

FIG. 3 is a schematic diagram of subframes of an LTE SL and slots of an NR SL according to the present application;

FIG. 4 is another schematic diagram of subframes of an LTE SL and slots of an NR SL according to the present application;

FIG. 5 is a schematic diagram of another application scenario in the prior art;

FIG. 6 is a schematic diagram of a further application scenario in the prior art;

FIG. 7 is a schematic diagram of a frame structure of an LTE-V2X system in the prior art;

FIG. 8 is a further schematic diagram of subframes of an LTE SL and slots of an NR SL in the prior art;

FIG. 9 is a schematic diagram of projecting sidelink data on a time domain symbol 81 according to the present application;

FIG. 10 is another schematic diagram of projecting sidelink data on a time domain symbol 81 according to the present application;

FIG. 11 is a further schematic diagram of projecting sidelink data on a time domain symbol 81 according to the present application;

FIG. 12 is yet another schematic diagram of subframes of an LTE SL and slots of an NR SL according to the present application;

FIG. 13 is yet another schematic diagram of subframes of an LTE SL and slots of an NR SL according to the present application;

FIG. 14 is yet another schematic diagram of subframes of an LTE SL and slots of an NR SL according to the present application;

FIG. 15 is yet another schematic diagram of subframes of an LTE SL and slots of an NR SL according to the present application;

FIG. 16 is yet another schematic diagram of subframes of an LTE SL and slots of an NR SL according to the present application;

FIG. 17 is yet another schematic diagram of subframes of an LTE SL and slots of an NR SL according to the present application;

FIG. 18 is a structural diagram of a terminal device according to the present application; and

FIG. 19 is another structure diagram of a terminal device according to the present application.

### DESCRIPTION OF EMBODIMENTS

In order to make objectives, technical solutions and advantages in embodiments of the present application clearer, technical solutions in the embodiments of the present application will be described clearly and completely below in combination with the accompanying drawings in the embodiments of the present application. Apparently, the described embodiments are merely a part rather than all embodiments of the present application. All other embodiments obtained by persons of ordinary skill in the art based on embodiments of the present application without paying creative effort shall fall within the protection scope of the present application.

The terms “first”, “second” and the like in the description, claims and the above accompanying drawings of the embodiments of the present application are used to distinguish similar objects, and are not necessarily used to describe a specific order or sequence. It should be understood that data used in this way can be interchanged under appropriate circumstances, so that the embodiments of the present application described herein can be implemented, for example, in a sequence other than those illustrated or described herein. In addition, the terms “include” and “have” and any variation of them are intended to cover non-exclusive inclusion. For example, a process, method, system, product or device that contains a series of steps or units need not be limited to those steps or units clearly listed, but may include other steps or units that are not clearly listed or are inherent to these processes, methods, products or devices.

Technical solutions in embodiments of the present application will be described below in combination with the accompanying drawings in the embodiments of the present application. Apparently, the described embodiments are merely a part rather than all embodiments of the present application. All other embodiments obtained by persons of ordinary skill in the art based on embodiments of the present application without paying creative effort shall fall within the protection scope of the present application.

The technical solutions of the embodiments of the present application can be applied to various communication systems, for example: a global system of mobile communication (GSM), a code division multiple access (CDMA) system, a wideband code division multiple access (WCDMA) system, general packet radio service (GPRS), an LTE system, an LTE frequency division duplex (FDD) system, an LTE time division duplex (TDD) system, an advanced long term evolution (LTE-A) system, an NR system, an evolution system of an NR system, an LTE-based access to unlicensed spectrum (LTE-U) system, an NR-based access to unlicensed spectrum (NR-U) system, a universal mobile telecommunication system (UMTS), a worldwide interoperability for microwave access (WiMAX) communication system, wireless local area networks (WLAN), wireless fidelity (WiFi), a next generation communication system or other communication systems, etc.

Generally speaking, traditional communication systems support a limited number of connections and are easy to implement. However, with the development of communication technology, mobile communication systems will not only support traditional communication, but also support, for example, D2D communication, machine to machine (M2M) communication, machine type communication (MTC), and vehicle to vehicle (V2V) communication, etc., the embodiment of the present application can also be applied to these communication systems.

Exemplarily, a communication system 100 applied in embodiments of the present application is shown in FIG. 1. The communication system 100 may include a network device 110, and the network device 110 may be a device that communicates with a terminal device 120 (or referred to as a communication terminal or a terminal). The network device 110 may provide communication coverage for a specific geographic area, and may communicate with a terminal device located in the coverage area. In an embodiment, the network device 110 may be a base transceiver station (BTS) in a GSM system or a CDMA system, or a NodeB (NB) in a WCDMA system, or an evolutional Node B (NB or eNodeB) in an LTE system, or a wireless controller in a cloud radio access network (CRAN), or the network device can be a mobile switching center, a relay station, an access point, an in-vehicle device, a wearable device, a hub, a switch, a network bridge, a router, a network-side device in a 5G network or a network device in a future evolved public land mobile network (PLMN), etc.

The communication system 100 further includes at least one terminal device 120 located within a coverage area of the network device 110. The “terminal device” used herein includes, but is not limited to, a connection via a wired line, such as a device that connects via a public switched telephone network (PSTN), a digital subscriber line (DSL), a digital cable, and a direct cable; and/or another data connection network; and/or via a wireless interface, for example, with respect to a cellular network, a wireless local area network (WLAN), a digital television network such as a digital video broadcasting handheld (DVB-H) network, a satellite network, an amplitude modulation frequency modulation (AM-FM) broadcast transmitter; and/or an apparatus of another terminal device that is set to receive/transmit communication signals; and/or an internet of things (IoT) device. A terminal device that is set to communicate through a wireless interface may be referred to as a “wireless communication terminal”, a “wireless terminal” or a “mobile terminal”. Examples of a mobile terminal include, but are not limited to, a satellite or a cellular phone; a personal communications system (PCS) terminal that can combine a cellular radio phone with data processing, fax, and data communication capabilities; a PDA that can include a radio phone, a pager, Internet/Intranet access, a web browser, a notepad, a calendar, and/or a global positioning system GPS) receiving terminal; and a conventional knee and/or palmtop receiving terminals or others electronic apparatuses including radio telephone transceivers. The terminal device can refer to an access terminal, a user equipment (UE), a user unit, a user station, a mobile station, a mobile platform, a remote station, a remote terminal, a mobile device, a user terminal, a terminal, a wireless communication device, a user agent, or a user apparatus. The access terminal can be a cellular phone, a cordless phone, a session initiation protocol (SIP) phone, a wireless local loop (WLL) station, a personal digital assistant (PDA), a handheld device with wireless communication functions, a computing device or other processing devices connected to a wireless modem, an in-vehicle device, a wearable device, a terminal device in a 5G network or a terminal device in a future evolved PLMN, etc.

In an embodiment, D2D communication may be performed between the terminal devices 120.

In an embodiment, the 5G system or 5G network may also be referred to as an NR system or an NR network.

FIG. 1 exemplarily shows one network device and two terminal devices. In an embodiment, the communication system 100 may include a plurality of network devices, and a coverage of each network device may include other numbers of terminal devices, which is not limited in the embodiment of the present application.

In FIG. 1, the network device may be an access device, for example, an access device in the NR-U system, such as a 5G NR base station (next generation Node B, gNB) or a small station or a micro station, or a relay station, a transmission and reception point (TRP), a road side unit (RSU), etc.

A terminal device can also be called mobile terminal, user equipment (UE), access terminal, user unit, user station, mobile station, mobile station, user terminal, terminal, wireless communication equipment, user agent or user device. Specifically, it can be a smart phone, a cellular phone, a cordless phone, a personal digital assistant (PDA) device, a handheld device with wireless communication functions or other processing devices connected to wireless modems, an in-vehicle device, a wearable device, etc. In the embodiments of the present application, the terminal device has an interface for communicating with a network device (for example, a cellular network).

In an embodiment, the communication system 100 may also include other network entities such as a network controller and a mobility management entity, which is not limited in the embodiments of the present application.

It should be understood that devices with communication functions in the network/system in the embodiments of the present application may be referred to as communication devices. Take the communication system 100 shown in FIG. 1 as an example, a communication device may include the network device 110 and the terminal device 120 with communication functions, and the network device 110 and the terminal device 120 may be the specific devices described above, which will not be repeated herein. The communication device may further include other devices in the communication system 100, such as other network entities, for example a network controller and a mobility management entity, which are not limited in the embodiments of the present application.

It should be understood that the terms “system” and “network” herein are often used interchangeably. The term “and/or” herein is merely an association relationship describing associated objects, and indicates that there may be three relationships. For example, A and/or B may indicate: presence of A only, of both A and B, and of B only. In addition, the character “/” herein generally indicates an “or” relationship between contextual objects.

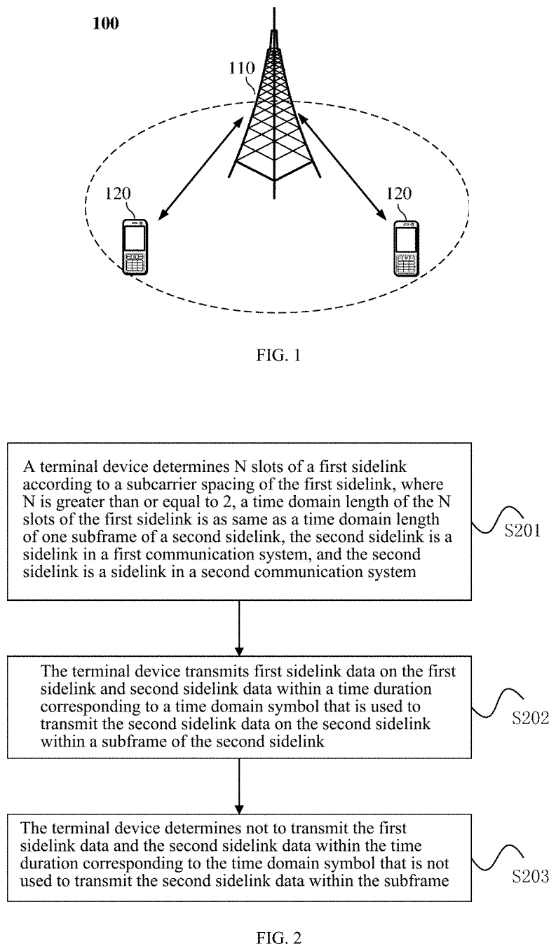

FIG. 2 is a flow chart of a sidelink data transmission method according to the present application. The method of the embodiment of the present application can be applied to an Internet of vehicles system. There are two different sidelinks in the Internet of vehicles system, one is a sidelink in a first communication system, and the other is a sidelink in a second communication system. In other words, in the Internet of vehicles system, a resource used for sidelink transmission can be a transmission resource in the first communication system or a transmission resource in the second communication system. As shown in FIG. 2, the sidelink data transmission method provided by this implementation specifically includes the following steps:

S201, a terminal device determines N slots of a first sidelink according to a subcarrier spacing of the first sidelink, where N is greater than or equal to 2, a time domain length of the N slots of the first sidelink is as same as a time domain length of one subframe of a second sidelink, the second sidelink is a sidelink in a first communication system, and the second sidelink is a sidelink in a second communication system.

In the embodiment, the subcarrier spacing of the first sidelink is different from that of the second sidelink, and a time domain length of one time unit of the first sidelink is different from that of one time unit of the second sidelink. The time unit may be a slot or a subframe. In an embodiment, the time unit of the first sidelink is a slot, and the time unit of the second sidelink is a subframe. In other words, the slot of the first sidelink and the subframe of the second sidelink are time units of the equal granularity. Here, the so-called equal granularity means that the number of time domain symbols included in one slot of the first sidelink equals to that included in one subframe of the second sidelink.

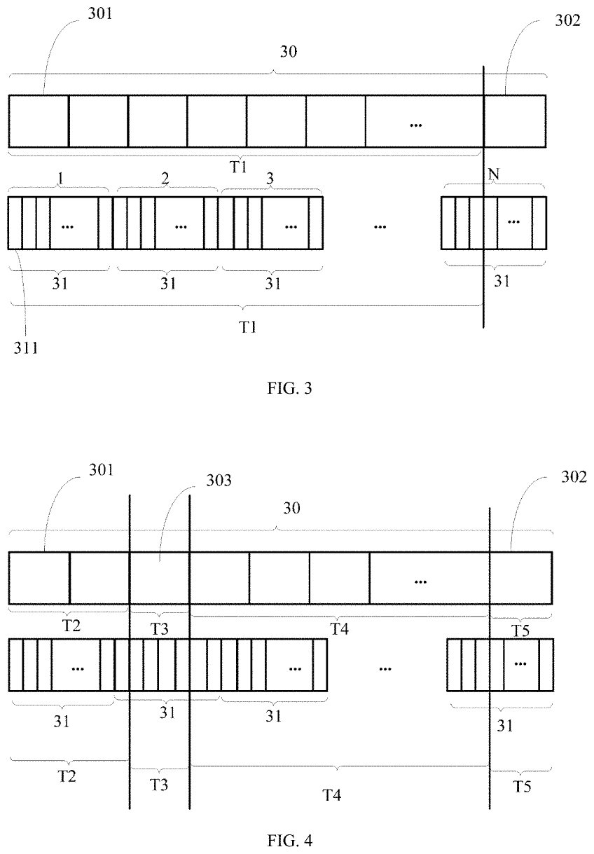

In the case that the subcarrier spacing of the first sidelink and the subcarrier spacing of the second sidelink are known, the terminal device can determine N slots of the first sidelink according to the subcarrier spacing of the first sidelink, so that the time domain length of the N slots of the first sidelink is as same as the time domain length of one subframe of the second sidelink. As shown in FIG. 3, 30 represents one subframe of the second sidelink, 31 represents one slot of the first sidelink, and a total time duration length corresponding to N slots 31 is as same as that corresponding to one subframe 30.

S202, the terminal device transmits first sidelink data on the first sidelink and second sidelink data within a time duration corresponding to a time domain symbol that is used to transmit the second sidelink data on the second sidelink within a subframe of the second sidelink.

As shown in FIG. 3, the subframe 30 includes a plurality of time domain symbols, 301 represents any one of the plurality of time domain symbols, and 302 represents a last time domain symbol of the plurality of time domain symbols. In an embodiment, a time domain length of each time domain symbol in the plurality of time domain symbols is the same. In the plurality of time domain symbols, part of the time domain symbols are used to transmit sidelink data on the second sidelink, and part of the time domain symbols may not be used to transmit the sidelink data on the second sidelink. In the embodiment, the sidelink data on the second sidelink can be denoted as the second sidelink data, and sidelink data on the first sidelink can be denoted as the first sidelink data. For example, the last time domain symbol within the subframe 30 is not used to transmit the second sidelink data, and other time domain symbols other than the last time domain symbol within the subframe 30 are used to transmit the second sidelink data.

In addition, as shown in FIG. 3, the slot 31 also includes a plurality of time domain symbols, and 311 represents any one of the plurality of time domain symbols included in the slot 31. In an embodiment, each of the time domain symbols included in the slot 31 has the same time domain length.

When the terminal device needs to simultaneously transmit the first sidelink data on the first sidelink and the second sidelink data on the second sidelink, the terminal device can first determine the time duration corresponding to the time domain symbol that is used to transmit the second sidelink data within the subframe of the second sidelink, such as T1 shown in FIG. 3. Time domain symbols of the subframe 30 corresponding to time duration T1, that is, the other time domain symbols except the last time domain symbol 302 within the subframe 30 all carry the second sidelink data. Time domain symbols of the slot 31 corresponding to time duration T1 all carry the first sidelink data. Further, the terminal device simultaneously transmits the first sidelink data and the second sidelink data in T1.

The above steps S201 and S202 are just one possible implementation of the sidelink data transmission method described in the embodiment.

Another possible implementation of the sidelink data transmission method described in the embodiment is: on the basis of step S201, it further includes: the terminal device does not transmit the first sidelink data and the second sidelink data within a time duration corresponding to a time domain symbol that is not used to transmit the second sidelink data within the subframe. In other words, the terminal device determines not to transmit the first sidelink data and the second sidelink data within the time duration corresponding to the time domain symbol that is not used to transmit the second sidelink data within the subframe. In the embodiment, where the terminal device determines not to transmit the first sidelink data and the second sidelink data within the time duration corresponding to the time domain symbol that is not used to transmit the second sidelink data within the subframe can be denoted as step S203.

A further possible implementation of the sidelink data transmission method described in the embodiment is to simultaneously include step S201, step S202 and step S203. Step S203 is described in detail below.

For S203, as shown in FIG. 3, the last time domain symbol 302 of the subframe 30 is not used to transmit the second sidelink data. Accordingly, the terminal device neither transmits the first sidelink data nor the second sidelink data within the time duration corresponding to the time domain symbol 302.

As shown in FIG. 3, part of time domain symbols used to transmit the second sidelink data within the subframe 30 are adjacent. The method described in the embodiment can also be applied to the case that the part of time domain symbols used to transmit the second sidelink data in one subframe of the second sidelink are not adjacent, as shown in FIG. 4, within the subframe 30 of the second sidelink, the time domain symbol 303 and the time domain symbol 302 are not used to transmit the second sidelink data, and other time domain symbols within the subframe 30 other than the time domain symbol 303 and the time domain symbol 302 are used to transmit the second sidelink data. That is to say, time durations corresponding to the time domain symbols that are used to transmit the second sidelink data within the subframe 30 are time duration T2 and time duration T4, and time duration s corresponding to the time domain symbols that are not used to transmit the second sidelink data within the subframe 30 are time duration T3 and time duration T5. In this case, the time domain symbols of the subframe 30 corresponding to time duration T2 and time duration T4 all carry the second sidelink data, and the time domain symbols of the slot 31 corresponding to time duration T2 and time duration T4 carry the first sidelink data. The terminal device simultaneously transmits the first sidelink data and the second sidelink data at time duration T2 and time duration T4, and/or, the terminal device determines not to transmit the first sidelink data and the second sidelink data at time duration T3 and time duration T5.

In the sidelink data transmission method provided by the embodiment, a terminal device determines N slots of a first sidelink according to a subcarrier spacing of the first sidelink, so that a time domain length of the N slots of the first sidelink is as same as a time domain length of one subframe of a second sidelink, when a certain time domain symbol within one subframe of the second sidelink is used to transmit second sidelink data on the second sidelink, the terminal device transmits the first sidelink data on the first sidelink and second sidelink data within a time duration corresponding to the time domain symbol, and/or, when a certain time domain symbol within one subframe of the second sidelink is not used to transmit the second sidelink data, the terminal device determines not to transmit the second sidelink data and the first sidelink data within the time duration corresponding to the time domain symbol, that is to say, when the terminal device transmits the sidelink data on either sidelink of the first sidelink and the second sidelink, the sidelink data on the other sidelink is also transmitted by the terminal device at the same time, and/or when the terminal device does not transmit the sidelink data on either sidelink of the first sidelink and the second sidelink, the sidelink data on the other sidelink is not transmitted by the terminal device either, thereby refraining the terminal device from transmitting the sidelink data on the other sidelink when transmitting the sidelink data on either sidelink of the two different sidelinks to the greatest extent, so that total power of the terminal device is evenly distributed on the first sidelink and the second sidelink as much as possible, and a dynamic change of transmission power on the first sidelink and the second sidelink is reduced or avoided. At the same time, the number of automatic gain controls at a receiving terminal is also reduced effectively, and the automatic gain control at the receiving terminal is even avoided, thereby improving the performance of the receiving terminal.

On the basis of the above embodiments, the first communication system can be a new radio NR system, and the second communication system can be a long term evolution LTE system.

In the embodiment, a resource used for sidelink transmission in the Internet of vehicles system can be a transmission resource in the LTE system or a transmission resource in the NR system. Here, a sidelink in the LTE system is denoted as LTE SL, a sidelink in the NR system is denoted as NR SL, and the NR SL is the first sidelink in the above embodiment, the LTE SL is the second sidelink in the above embodiment. In the Internet of vehicles system, the LTE SL and the NR SL coexist. A coexistence mode of LTE SL and NR SL can be intra-band coexistence or inter-band coexistence. When the coexistence mode of the LTE SL and the NR SL is intra-band coexistence, the LTE SL and the NR SL work in the same frequency band, for example, in a 5.9 GHz frequency band. The 5.9 GHz frequency band includes a plurality of carriers, and the LTE SL and the NR SL use different carriers among the plurality of carriers. For example, there are two adjacent carriers in the plurality of carriers, which are denoted as carrier 0 and carrier 1. A bandwidth of each carrier is 10 MHz. The LTE SL uses carrier 0 and the NR SL uses carrier 1.

When the coexistence mode of the LTE SL and the NR SL is inter-band coexistence, the LTE SL and the NR SL work in different frequency bands. For example, the LTE SL works in the 5.9 GHz frequency band and the NR SL works in a 3.6 GHz frequency band. The LTE SL uses a carrier in the 5.9 GHz frequency band, and the NR SL uses a carrier in the 3.6 GHz frequency band.

It can be understood that intra-band coexistence and inter-band coexistence are divided according to whether the LTE SL and the NR SL work in the same frequency band, that is to say, intra-band coexistence and inter-band coexistence are a division method of LTE SL and NR SL coexistence. In addition, according to a multiplexing mode of LTE SL and NR SL, the coexistence modes of the LTE SL and the NR SL can be divided into a time division multiplexing (TDM) mode and a frequency division multiplexing (FDM) mode. In the TDM mode, the LTE SL and the NR SL are time division multiplexing. The terminal device transmits sidelink data on the LTE SL and sidelink data on the NR SL at different times, that is to say, only the sidelink data on one kind of the SLs is transmitted at the same time. In the FDM mode, the LTE SL and the NR SL are frequency division multiplexing, and the terminal device simultaneously transmits the sidelink data on the LTE SL and the sidelink data on the NR SL on different carriers. Here, the sidelink data on the LTE SL corresponds to the second sidelink data described in the above embodiment, and the sidelink data on the NR SL corresponds to the first sidelink data described in the above embodiment.

In the FDM mode, the carrier used to transmit the first sidelink data can be denoted as a first carrier, and the carrier used to transmit the second sidelink data can be denoted as a second carrier. The first carrier and the second carrier can be different carriers in the same frequency band or different carriers in different frequency bands. When transmitting the second sidelink and the first sidelink data, the terminal device can transmit the second sidelink on the second carrier and the first sidelink data on the first carrier.

When the first carrier and the second carrier are different carriers in the same frequency band, and the same terminal device simultaneously transmits the second sidelink and the first sidelink data, the total transmission power of the terminal device may be dynamically shared by the LTE SL and the NR SL. When the first carrier and the second carrier are different carriers in different frequency bands, and the same terminal device simultaneously transmits the second sidelink and the first sidelink data, the total transmission power of the terminal device will not be dynamically shared by the LTE SL and the NR SL. Therefore, the method described in the embodiment can be applied to the scenario where frequency division multiplexing is adopted for the LTE SL and the NR SL, and the first carrier and the second carrier are different carriers in the same frequency band.

In the sidelink data transmission method provided by the embodiment, when transmitting the sidelink data on either sidelink of the LTE SL and the NR SL by the terminal device, the sidelink data on the other sidelink is also transmitted by the terminal device, and/or when the terminal device does not transmit the sidelink data on either sidelink of the LTE SL and the NR SL, the sidelink data on the other sidelink is not transmitted by the terminal device either, thereby refraining the terminal device from transmitting the sidelink data on the other sidelink when transmitting the sidelink data on either sidelink of the LTE SL or the NR SL to the greatest extent, so that total power of the terminal device is evenly distributed on the LTE SL and the NR SL as much as possible, and a dynamic change of transmission power on the LTE SL and the NR SL is reduced or avoided. At the same time, the number of automatic gain controls at a receiving terminal in the Internet of vehicles system is also reduced effectively, and the automatic gain control at the receiving terminal is even avoided, thereby improving the performance of the receiving terminal.

In addition, the Internet of vehicles is not limited to D2D communication, but also includes V2V communication, vehicle to pedestrian (V2P) communication, vehicle to infrastructure/network (V2I/N) communication, etc. D2D communication, V2V communication, V2P communication and V2I/N communication can be collectively referred to as vehicle to everything (V2X) communication. Here, V2X based on a transmission resource of an LTE system can be denoted as LTE-V2X, and V2X based on a transmission resource of an NR system can be denoted as NR-V2X.

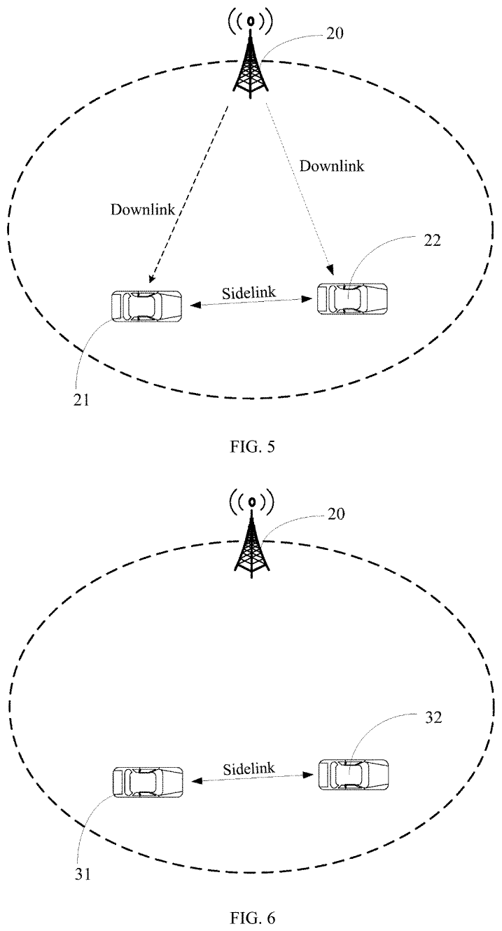

When the terminal device needs to simultaneously transmit the second sidelink data and the first sidelink data, the terminal device needs to acquire a transmission resource in the LTE system and a transmission resource in the NR system. The manner in which the terminal device acquires the transmission resource in the LTE system can include the following modes, which are denoted as mode 3 and mode 4. In the mode 3, the transmission resource of a terminal device, such as a vehicle terminal, is allocated by a base station. As shown in FIG. 5, a base station 20 allocates a transmission resource to an in-vehicle terminal A in a vehicle 21 and an in-vehicle terminal B in a vehicle 22 respectively through downlink. The in-vehicle terminal A and the in-vehicle terminal B transmit sidelink data on sidelinks according to transmission resources allocated by the base station 20. The base station 20 can allocate resources for a single transmission to the in-vehicle terminal A and the in-vehicle terminal B, or semi-static transmission resources to the in-vehicle terminal A and the in-vehicle terminal B. Here, the so-called semi-static transmission resource means that the vehicle terminal can continuously use a transmission resource in a plurality of transmission periods after the base station allocates said transmission resource to the vehicle terminal. In addition, in some scenarios, the base station 20 can also allocate a transmission resource to one of the in-vehicle terminal A and the in-vehicle terminal B. for example, the base station 20 allocates a transmission resource to the in-vehicle terminal A, and the in-vehicle terminal A can transmit sidelink data to the in-vehicle terminal B according to the transmission resource.

In the mode 4, the in-vehicle terminal transmits sidelink data by means of sensing and reserving a transmission resource. Specifically, an in-vehicle terminal acquires an available transmission resource set from a resource pool by means of sensing, and randomly selects a transmission resource from the available transmission resource set to transmit the sidelink data. Due to a periodicity of a service in the LTE-V2X system, the in-vehicle terminal can adopt a semi-static transmission mode, that is, after selecting a transmission resource, the in-vehicle terminal will continue to use the transmission resource in the plurality of transmission periods, so as to reduce a probability of transmission resource reselections and transmission resource conflicts. While transmitting sidelink data to a receiving terminal, the in-vehicle terminal, as a transmitting terminal, can further transmit sidelink control information which can carry information for reserving the resource for the next transmission, so that other in-vehicle terminals can determine whether the transmission resource is reserved and used by the in-vehicle terminal through the sidelink control information, so as to achieve a purpose of reducing transmission resource conflicts. As shown in FIG. 6, an in-vehicle terminal C in a vehicle 31 senses and reserves the transmission resource, and transmits sidelink data to an in-vehicle terminal D in a vehicle 32 according to the transmission resource. While transmitting the sidelink data, the in-vehicle terminal C can also transmit sidelink control information which carries information for reserving the transmission resource. In this way, the in-vehicle terminal D, or other in-vehicle terminals other than the in-vehicle terminal C and the in-vehicle terminal D, can determine that the transmission resource has been reserved and used by the in-vehicle terminal C. In other embodiments, in the mode 4, the in-vehicle terminal can also randomly select a transmission resource from a resource pool configured by a network device for sidelink data transmission.

Modes for the terminal device to acquire the transmission resource in the NR system can include the following: mode 1 and mode 2. In the mode 1, the network device allocates a transmission resource to the terminal device, which is similar to the mode 3 in the LTE-V2X system. In the mode 2, the terminal device selects a transmission resource independently in a configured resource pool, which is similar to the mode 4 in the LTE-V2X system, and the specific principle will not be described herein.

In the embodiment, since the first sidelink and the second sidelink are sidelinks in different communication systems, the subcarrier spacing of the first sidelink and the subcarrier spacing of the second sidelink may be different. In an embodiment, the subcarrier spacing of the first sidelink is N times that of the second sidelink. A time domain length of one time domain symbol of the second sidelink is equal to a time domain length of N time domain symbols of the first sidelink. In the embodiment, an example is taken where the first communication system is an NR system and the second communication system is an LTE system for schematic illustration. Accordingly, a subcarrier spacing of the NR system is N times that of the LTE system, and a time domain length of one time domain symbol of the LTE system is equal to that of N time domain symbols of the NR system.

Specifically, the subcarrier spacing of the LTE SL is fixed, for example, fixed at 15 kHz, and one subframe of the LTE SL occupies 1 millisecond in the time domain. The NR SL can have a plurality of subcarrier spacings. For example, when the terminal device operates in a frequence range 1 (FR1), the NR SL supports subcarrier spacings of 15 kHz, 30 kHz and 60 KHZ; when the terminal device operates in a frequence range 2 (FR2), the NR SL supports subcarrier spacings of 60 kHZ and 120 kHz. For different subcarrier spacings of the NR SL, the time duration lengths of one slot of the NR SL in the time domain are also different. In the embodiment, an example is taken where one slot of the NR SL and one subframe of the LTE SL both include the same number of time domain symbols. For example, one slot of the NR SL and one subframe of the LTE SL both include 14 time domain symbols. The time domain symbols may specifically be orthogonal frequency division multiplexing (OFDM) symbols.

When the subcarrier spacing of the NR SL is 15 kHz, one slot of the NR SL occupies 1 millisecond, that is, when the subcarrier spacing of the NR SL is as same as that of the LTE SL, a time domain length of one slot of the NR SL is equal to that of one subframe of the LTE SL, and a time domain length of one time domain symbol of the NR SL is equal to that of one time domain symbol of the LTE SL.

When the subcarrier spacing of the NR SL is 30 kHz, one slot of the NR SL occupies 0.5 millisecond, that is, when the subcarrier spacing of the NR SL is twice that of the LTE SL, the time domain length of one subframe of the LTE SL is as same as that of two slots of the NR SL, and the time domain length of one time domain symbol of the LTE SL is as same as that of two time domain symbols of the NR SL.

When the subcarrier spacing is 60 kHz, one slot occupies 0.25 millisecond, that is, when the subcarrier spacing of the NR SL is four times that of the LTE SL, the time domain length of one subframe of the LTE SL is as same as that of four slots of the NR SL, and the time domain length of one time domain symbol of the LTE SL is as same as that of four time domain symbols of the NR SL.

When the subcarrier spacing is 120 kHz, one slot occupies 0.125 millisecond, and when the subcarrier spacing of the NR SL is eight times that of the LTE SL, the time domain length of one subframe of the LTE SL is as same as that of eight slots of the NR SL, and the time domain length of one time domain symbol of the LTE SL is as same as that of eight time domain symbols of the NR SL.

In conclusion, when the NR SL and the LTE SL adopt different subcarrier spacings, time duration lengths of one subframe of the LTE SL and one slot of the NR SL will be different. The NR SL supports several kinds of subcarrier spacings as described in Table 1 below.

TABLE 1

| μ | Δƒ = 2^{μ} × 15[kHz] |
|---|---|
| 0 | 15 |
| 1 | 30 |
| 2 | 60 |
| 3 | 120 |

When the subcarrier spacing of the NR SL is 2^{μ}×15 kHz, the time duration length of one subframe of the LTE SL is equal to a sum of time duration lengths of 2μ slots of the NR SL. N in the above embodiment can be specifically 2^{μ}, μ=1, 2, 3 described here.

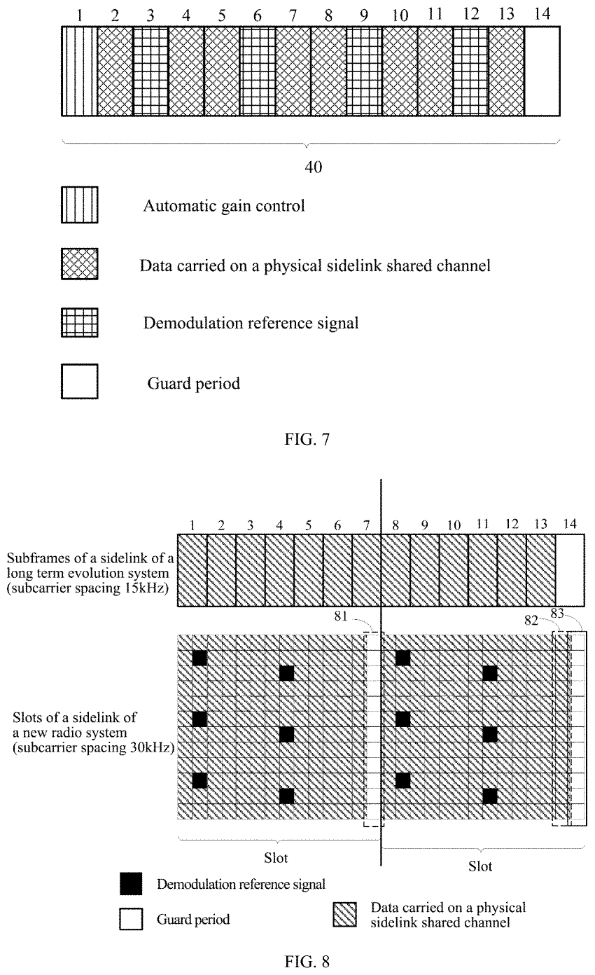

On the basis of the above embodiment, after acquiring the transmission resource in the LTE system and the transmission resource in the NR system, the terminal device can map the sidelink data on the transmission resource in the LTE system and the transmission resource in the NR system respectively. Here, the sidelink data mapped by the terminal device on the transmission resource in the LTE system can be denoted as the second sidelink data, the sidelink data mapped by the terminal device on the transmission resource in the NR system can be denoted as the first sidelink data. As shown in FIG. 7, a frame structure of an LTE-V2X system can be a frame structure of a physical sidelink shared channel (PSSCH) or a physical sidelink control channel (PSCCH). 40 is denoted as one subframe, and a time duration length of one subframe in the time domain is 1 millisecond. One subframe includes 14 time domain symbols. Specifically, a first time domain symbol of the 14 time domain symbols is usually used for automatic gain control (AGC), and a last time domain symbol is usually a guard period (GP) symbol. The transmitting terminal can map data on the first time domain symbol, that is, the transmitting terminal can map data on an AGC symbol. However, the receiving terminal uses the first time domain symbol for AGC, and data on the first time domain symbol is usually not used for data demodulation. The transmitting terminal does not transmit data on a GP symbol, and the GP symbol is usually used for receiving and transmitting conversion or transmitting and receiving conversion.

As shown in FIG. 7, there are four time domain symbols within the subframe 40 used to carry a demodulation reference signal (DMRS). Specifically, a third time domain symbol, a sixth time domain symbol, a ninth time domain symbol, and a twelfth time domain symbol carry the DMRS. In addition, a second time domain symbol, a fourth time domain symbol, a fifth time domain symbol, a seventh time domain symbol, an eighth time domain symbol, a tenth time domain symbol, an eleventh time domain symbol, and a thirteenth time domain symbol can be mapped with data carried on the PSSCH. It can be understood that this is only schematic descriptions, rather than limitations on the specific data mapped on the subframe 40. For example, part of time domain symbols within the subframe 40 can also be mapped with data carried on the PSCCH. In the embodiment, a mode for mapping the data carried on the PSCCH onto the subframe 40 is limited. It can be as same as or different from a mode for mapping the data carried on the PSCCH onto the subframe 40.

In addition, the terminal device can also map the second sidelink data on the transmission resource in an LTE system in a way shown in FIG. 8, that is, first thirteen time domain symbols of one subframe of an LTE SL are mapped with the second sidelink data, the second sidelink data can be the data carried on the PSSCH, and a last time domain symbol of the one subframe of the LTE SL is not mapped with the second sidelink data.

Further, the terminal device can also map the first sidelink data on the transmission resource in an NR system in a way shown in FIG. 8. As shown in FIG. 8, a time domain length of one subframe of the LTE SL is equal to a sum of time domain lengths of two slots of the NR SL. The terminal device can map the first sidelink data on first thirteen time domain symbols of each of the two slots of the NR SL. For example, the first sidelink data can be the data carried on the PSSCH, and the terminal device may not map the first sidelink data on a last time domain symbol of each of the two slots of the NR SL.

However, as shown in FIG. 8, a time domain symbol 81 is a GP symbol. Since the terminal device does not map the first sidelink data on the time domain symbol 81, there is second sidelink data to be transmitted on the LTE SL within a time duration corresponding to the time domain symbol 81, but there is no first sidelink data to be transmitted on the NR SL, which will lead to a dynamic change of transmission power on two different sidelinks in the time duration corresponding to the time domain symbol 81. In addition, as shown in FIGS. 8, 82 and 83 represent last two time domain symbols of a second slot of the two slots of the NR SL. A sum of the time domain lengths of the time domain symbols 82 and 83 is equal to a time domain length of the last time domain symbol of one subframe of the LTE SL. Because there is no second sidelink data mapped on the last time domain symbol of the one subframe of the LTE SL, and the first sidelink data is mapped on the time domain symbol 82, thus there is no second sidelink data transmitted on the LTE SL within the time duration corresponding to the time domain symbol 82. However, there is first sidelink data on the NR SL, which also lead to the dynamic change of transmission power on two different sidelinks in the time duration corresponding to the time domain symbol 82.

Therefore, in view of the above problem, in order to reduce the dynamic change of transmission power on two different sidelinks, an implementation manner is that the first sidelink data is mapped on a last time domain symbol of each of first N−1 slots of N slots of the first sidelink. In an embodiment, the first sidelink data mapped on the last time domain symbol of each of the first N−1 slots includes at least one of the following: data carried on a physical sidelink shared channel PSSCH, a demodulation reference signal DMRS, a channel state information-reference signal CSI-RS, a sounding reference signal SRS and data randomly generated by the terminal device.

As shown in FIG. 3, a time domain length of one subframe 30 of the LTE SL is equal to a sum of time domain lengths of N slots 31 of the NR SL. Last time domain symbol of each slot 31 is a GP symbol. Because the transmitting terminal does not transmit data on the GP symbol, in order to reduce the dynamic change of transmission power on two different sidelinks, the terminal device can map the first sidelink data on a last time domain symbol of each of first N−1 slots of the N slots 31, and simultaneously transmit the second sidelink data on the LTE SL and the first sidelink data on the NR SL within the time duration T1.

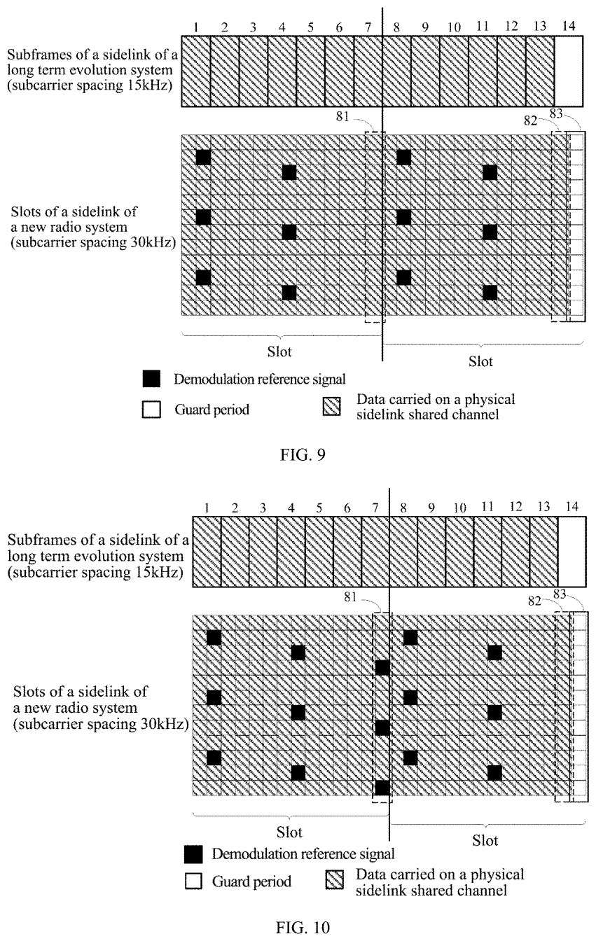

Take N=2 as an example, as shown in FIG. 9-FIG. 11, on the basis of FIG. 8, the terminal device maps the first sidelink data on the time domain symbol 81.

The first sidelink data mapped on the time domain symbol 81 may include at least one of the following: data carried on a physical sidelink shared channel PSSCH, a demodulation reference signal DMRS, a channel state information-reference signal (CSI-RS), a sounding reference signal (SRS) and data randomly generated by the terminal device.

As shown in FIG. 9, the first sidelink data mapped on the time domain symbol 81 is the data carried on the physical sidelink shared channel PSSCH, and the terminal device transmits the first sidelink data mapped on the time domain symbol 81. This manner can increase a transmission resource corresponding to the PSSCH, reduce a code rate and improve a performance of the terminal device.

As shown in FIG. 10, the first sidelink data mapped on the time domain symbol 81 is the data carried on the physical sidelink shared channel PSSCH and the demodulation reference signal DMRS. The performance of channel estimation can be improved by mapping the DMRS on the GP symbol.

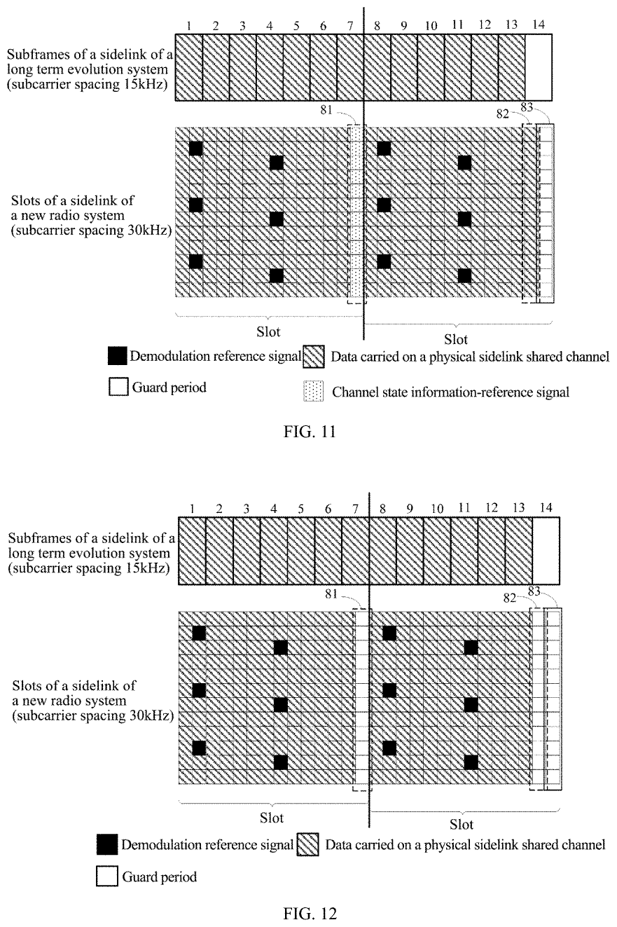

As shown in FIG. 11, the first sidelink data mapped on the time domain symbol 81 is the channel state information-reference signal CSI-RS. This manner helps to obtain channel state information by the receiving terminal. The channel state information (CSI) includes at least one of the following: a channel quality indicator (CQI), a precoding matrix indicator (PMI) and a rank indicator (RI). In addition, the receiving terminal can perform channel measurement or channel estimation according to the CSI-RS, for example, the receiving terminal can measure sidelink reference signal received power (S-RSRP), a sidelink received signal strength indicator (S-RSSI), etc., and feed back a result of channel measurement or channel estimation to the transmitting terminal.

It could be understood that a bandwidth of the first sidelink data filled on the GP symbol, such as the time domain symbol 81, is consistent with that of the data on other symbols. In addition, according to FIGS. 9, 10 and 11, after the first sidelink data is filled on the time domain symbol 81, the transmission power on the two different sidelinks does not change dynamically during the time duration corresponding to the time domain symbol 81. However, if the time domain symbol 82 is used to transmit the first sidelink data, then the transmission power on the two different sidelinks may still change dynamically during the time duration corresponding to the time domain symbol 82.

In the sidelink data transmission method provided by the embodiment, through mapping of the first sidelink data on a last time domain symbol of each of the first N−1 slots of N slots of the NR SL, the dynamic change or dynamic adjustment of transmission power on the NR SL and the LTE SL is reduced.

In order to reduce the dynamic change of transmission power on two different sidelinks, another possible way is that last N time domain symbols in the Nth slot of the N slots are not used to transmit the first sidelink data. In an embodiment, the last time domain symbol in each of the N slots is a guard period GP symbol. As shown in FIG. 3, the time domain length of one subframe 30 of the LTE SL is equal to the sum of the time domain lengths of N slots 31 of the NR SL. The time domain length of one time domain symbol of the LTE SL is equal to the sum of the time domain lengths of N time domain symbols of the NR SL. For example, a time domain length of the last time domain symbol 302 of the LTE SL is equal to a sum of time domain lengths of the last N time domain symbols in the last slot 31 of the NR SL. Since the last time domain symbol 302 of the LTE SL is a GP symbol, the terminal device does not transmit the second sidelink data on the GP symbol such as the time domain symbol 302. Therefore, the last N time domain symbols in the last slot 31 of the NR SL may not be used to transmit the first sidelink data.

Take N=2 as an example, on the basis of FIG. 8, the time domain symbol 82 and the time domain symbol 83 may not be used to transmit sidelink data in the following way.

One way is: first N−1 time domain symbols in last N time domain symbols in the Nth slot of the N slots are mapped with the first sidelink data, and the first sidelink data mapped on the first N−1 time domain symbols are not transmitted by the terminal device. In an embodiment, the first sidelink data mapped on the first N−1 time domain symbols includes data carried on a physical sidelink shared channel PSSCH.

As shown in FIGS. 8, 82 and 83 represent last two time domain symbols of the second slot in the two slots of the NR SL, where the time domain symbol 82 is a first time domain symbol of the last two time domain symbols in the second slot, and the terminal device can map the first sidelink data on the time domain symbol 82 in a normal way, that is to say, the terminal device can perform resource mapping in accordance with separate transmitting of the first sidelink data on one slot of the NR SL, for example, the terminal device does not map the first sidelink data on the last time domain symbol 83 of the second slot, and maps the first sidelink data on other time domain symbols of the second slot, for example, maps the data carried on the physical sidelink shared channel PSSCH. However, the terminal device does not transmit the first sidelink data mapped on the time domain symbol 82. That is to say, even if the terminal device has the first sidelink data mapped on the time domain symbol 82, the terminal device does not transmit the first sidelink data mapped on the time domain symbol 82, therefore, the time domain symbol 82 is not used to transmit the first sidelink data. In addition, the time domain symbol 83 is a GP symbol, and the terminal device does not transmit data on the GP symbol. Therefore, neither the time domain symbol 82 nor the time domain symbol 83 is used to transmit the first sidelink data.

Another way is: first N−1 time domain symbols in the last N time domain symbols in the Nth slot of the N slots are not mapped with the first sidelink data.

As shown in FIG. 12, the terminal device does not map the first sidelink data on the time domain symbol 82. That is to say, the time domain symbol 82 is not mapped with the first sidelink data, so the time domain symbol 82 cannot be used to transmit the first sidelink data. As described above, the time domain symbol 83 is a GP symbol, and the terminal device does not transmit data on the GP symbol. Therefore, neither the time domain symbol 82 nor the time domain symbol 83 is used to transmit the first sidelink data. In the second slot of the NR SL, the first sidelink data is mapped on all time domain symbols except the time domain symbol 82 and the time domain symbol 83.

As shown in FIG. 12, the last time domain symbol within the subframe of an LTE SL corresponds to the time domain symbol 82 and the time domain symbol 83 of an NR SL. In addition, the last time domain symbol within the subframe of the LTE SL is a GP symbol, and the terminal device does not transmit the second sidelink data on the GP symbol. Therefore, when both of the time domain symbol 82 and the time domain symbol 83 are not used to transmit the first sidelink data, the terminal device neither transmits the first sidelink data nor the second sidelink data during a time duration corresponding to the time domain symbol 82 and the time domain symbol 83.

In the sidelink data transmission method provided by the embodiment, since the last N time domain symbols in the Nth slot of the N slots of the NR SL are not used to transmit the first sidelink data, the dynamic change or dynamic adjustment of transmission power on the NR SL and the LTE SL is reduced.

In conclusion, the last time domain symbol in each of first N−1 slots of the N slots is mapped with the first sidelink data, or the last N time domain symbols in the Nth slot of the N slots are not used to transmit the first sidelink data, which can reduce the dynamic change of transmission power on two different sidelinks. However, the dynamic change of transmission power on two different sidelinks is still not avoided. The terminal device shown in FIGS. 9-11 maps the first sidelink data on the time domain symbol 81, or the time domain symbol 82 and the time domain symbol 83 shown in FIG. 12 are not used to transmit the first sidelink data, which reduces the dynamic change of transmission power on two different sidelinks compared with the manner shown in FIG. 8 in which only two slots of the NR SL are used to complete one subframe of the LTE SL. However, the dynamic change of transmission power on two different sidelinks is still not avoided. In order to avoid the dynamic change of transmission power on two different sidelinks, one possible way is: the last time domain symbol in each of first N−1 slots of the N slots is mapped with the first sidelink data, and the last N time domain symbols in the Nth slot of the N slots are not used to transmit the first sidelink data.

For example, on the basis of FIG. 8, the terminal device may map the first sidelink data on the time domain symbol 81, and neither the time domain symbol 82 nor the time domain symbol 83 is used to transmit the first sidelink data.

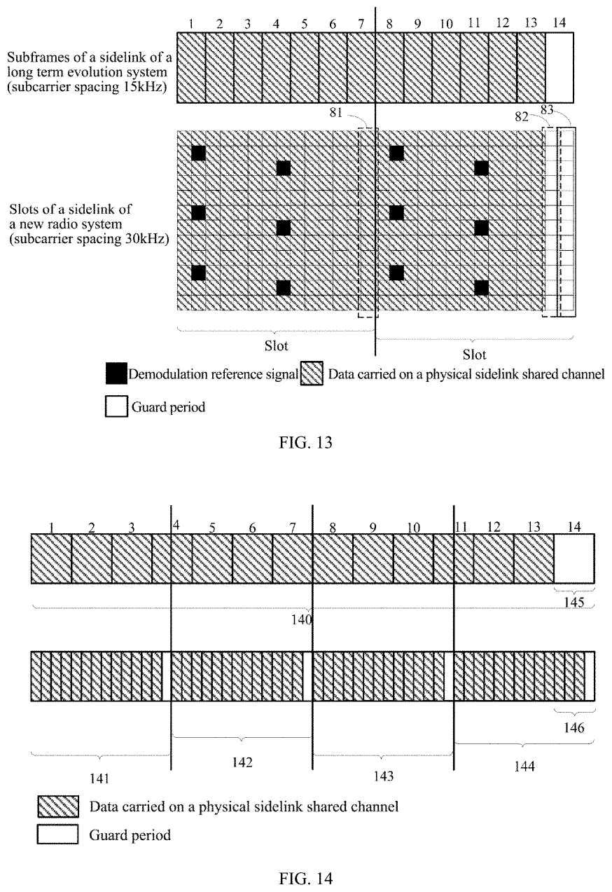

As shown in FIG. 13, the first sidelink data mapped on the time domain symbol 81 is data carried on a PSSCH. Here, there is no limitation on the first sidelink data mapped on the time domain symbol 81, which can also be other information other than the data carried on the PSSCH.

One implementation manner to realize that the time domain symbol 82 and the time domain symbol 83 are not used to transmit the first sidelink data is that: the terminal device has the first sidelink data mapped on the time domain symbol 82, but the terminal device does not transmit the first sidelink data mapped on the time domain symbol 82. The time domain symbol 83 is the GP symbol, and the terminal device does not map the first sidelink data on the time domain symbol 83.

Another implementation manner to realize that the time domain symbol 82 and the time domain symbol 83 are not used to transmit the first sidelink data is that: the terminal device does not map the first sidelink data on the time domain symbol 82 and the time domain symbol 83, as specifically shown in FIG. 13.

In addition, as can be seen from FIG. 13, the terminal device maps the first sidelink data on the time domain symbol 81, and the time domain symbol 82 and the time domain symbol 83 are not used to transmit the first sidelink data, in this way, the transmission power allocated to the LTE SL and the NR SL is always the same in a process of frequency division multiplexing of the LTE SL and the NR SL, thus effectively avoiding the dynamic change of transmission power on the two different sidelinks.

In the sidelink data transmission method provided by the embodiment, the first sidelink data is mapped on the last time domain symbol of each of the first N−1 slots of N slots of the NR SL, and the last N time domain symbols in the Nth slot of the N slots are not used to transmit the first sidelink data, thereby ensuring that, in one subframe of the LTE SL, the transmission power allocated to the LTE SL and the NR SL is always the same, thus avoiding the dynamic change or dynamic adjustment of transmission power on the NR SL and the LTE SL.

In the above embodiments, N=2 is taken as an example. In this embodiment, the value of N may not be limited to 2. For example, in this embodiment, N may be equal to 4 or 8.

Take N=4 as an example, as shown in FIG. 14, 140 represents one subframe of an LTE SL, 141-144 represents one slot of an NR SL respectively, a subcarrier spacing of the NR SL is four times that of the LTE SL, and a time duration length of one subframe of the LTE SL is equal to a sum of time duration lengths of four slots of the NR SL. And a time duration length of four time domain symbols of the NR SL is as same as that of one time domain symbol of the LTE SL. For example, 145 represents a last time domain symbol within the subframe of the LTE SL. 146 represents last four time domain symbols of a fourth slot of the four slots of the NR SL. The last time domain symbol within the subframe of the LTE SL corresponds to the last four time domain symbols of the fourth slot of the NR SL.

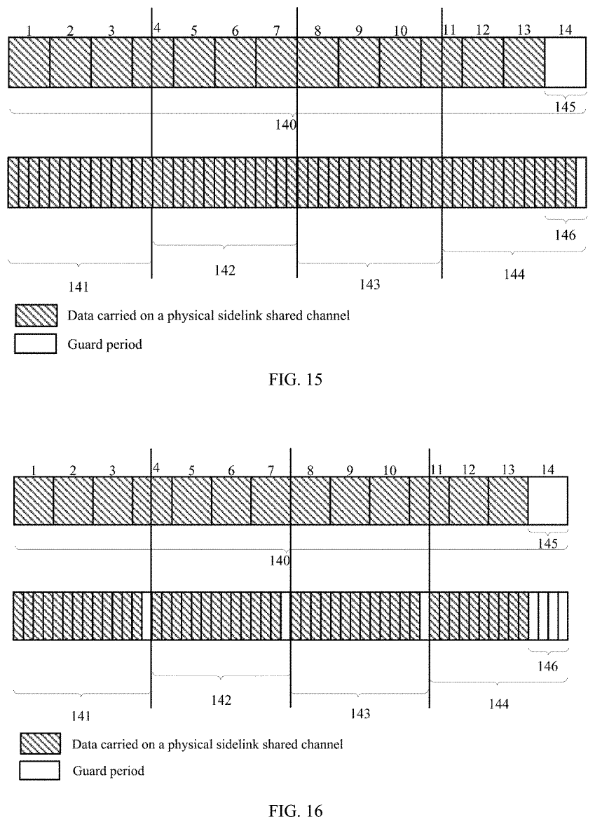

In order to reduce the dynamic change of transmission power on two different sidelinks, the terminal device can map the first sidelink data on the last time domain symbol of each of first three slots of the four slots of the NR SL as shown in FIG. 14. The first sidelink data that can be mapped here is consistent with the first sidelink data that can be mapped on the time domain symbol 81 described in the above embodiment, which will not be repeated herein. As shown in FIG. 15, the last time domain symbol of each of the first three slots of the four slots of the NR SL is mapped with the data carried on the PSSCH.

In addition to the above method, another implementation to reduce the dynamic change of transmission power on two different sidelinks is that, on the basis of FIG. 14, the terminal device normally maps the first sidelink data on first three time domain symbols of the last four time domain symbols of the slot 144, but the terminal device does not transmit the first sidelink data mapped on the first three time domain symbols of the last four time domain symbols of the slot 144. Alternatively, as shown in FIG. 16, the terminal device does not map the first sidelink data on the last four time domain symbols of the slot 144.

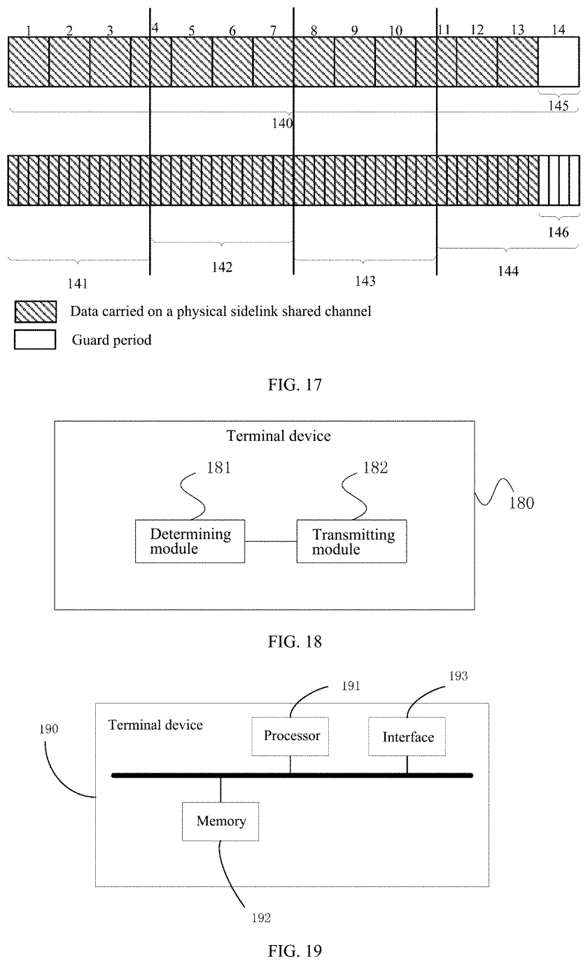

Another implementation manner is a way shown in FIG. 17, that is, the terminal device maps the first sidelink data on the last time domain symbol of each of the first three slots of the four slots of the NR SL, at the same time, the terminal device does not map the first sidelink data on the last four time domain symbols of the slot 144. In this way, the transmission power allocated to the LTE SL and the NR SL is always the same in a process of frequency division multiplexing of the LTE SL and the NR SL, thus effectively avoiding the dynamic change of transmission power on the two different sidelinks.

It can be understood that when N=8, a possible implementation to reduce or avoid the dynamic change of transmission power on two different sidelinks is as same as the method described in the above embodiment, which will not be repeated herein.

In the sidelink transmission method provided by the embodiment, the first sidelink data is mapped on the last time domain symbol of each of the first N−1 slots of the N slots of the NR SL, and the first sidelink data is not transmitted on the last N time domain symbols in the Nth slot of the N slots of the NR SL, thereby ensuring that the transmission power allocated to the LTE SL and the NR SL is always the same in one subframe of the LTE SL, thus avoiding the dynamic change or dynamic adjustment of transmission power on the NR SL and the LTE SL.

FIG. 18 is a structural diagram of a terminal device according to the present application. As shown in FIG. 18, the terminal device 180 includes:

a determining module 181, configured to determine N slots of a first sidelink according to a subcarrier spacing of the first sidelink, where N is greater than or equal to 2, a time domain length of the N slots of the first sidelink is as same as a time domain length of one subframe of a second sidelink, the second sidelink is a sidelink in a first communication system, and the second sidelink is a sidelink in a second communication system; and

a transmitting module 182, configured to transmit first sidelink data on the first sidelink and second sidelink data within a time duration corresponding to a time domain symbol that is used to transmit the second sidelink data on the second sidelink within a subframe of the second sidelink; and/or, not transmit the first sidelink data and the second sidelink data within a time duration corresponding to a time domain symbol that is not used to transmit the second sidelink data within the subframe.

The terminal device provided in the embodiment is configured to implement the technical solution of the terminal device side in any of the above method embodiments, and its implementation principle and technical effect are similar, which will not be repeated herein.

On the basis of the embodiment shown in FIG. 18, the first communication system is a new radio NR system, and the second communication system is a long term evolution LTE system.

In an embodiment, a last time domain symbol in each of first N−1 slots of the N slots is mapped with the first sidelink data.

In an embodiment, the first sidelink data mapped on the last time domain symbol in each of the first N−1 slots includes at least one of the following:

data carried on a physical sidelink shared channel PSSCH, a demodulation reference signal DMRS, a channel state information-reference signal CSI-RS, a sounding reference signal SRS and data randomly generated by the terminal device.

In an embodiment, last N time domain symbols in Nth slot of the N slots are not used to transmit the first sidelink data.

In an embodiment, a last time domain symbol in each of the N slots is a guard period GP symbol.

In an embodiment, first N−1 time domain symbols in the last N time domain symbols in the Nth slot of the N slots are mapped with the first sidelink data, and the first sidelink data mapped on the first N−1 time domain symbols are not transmitted by the terminal device.

In an embodiment, the first sidelink data mapped on the first N−1 time domain symbol includes data carried on a physical sidelink shared channel PSSCH.

In an embodiment, first N−1 time domain symbols in the last N time domain symbols in the Nth slot of the N slots are not mapped with the first sidelink data.

In an embodiment, the subcarrier spacing of the first sidelink is N times a subcarrier spacing of the second sidelink.

In an embodiment, a time domain length of one time domain symbol of the second sidelink is equal to a time domain length of N time domain symbols of the first sidelink.

In an embodiment, when transmitting the second sidelink and the first sidelink data on the first sidelink, the transmitting module is specifically configured to: transmit the second sidelink data on a second carrier and transmit the first sidelink data on a first carrier.

In an embodiment, the first carrier and the second carrier are different carriers within a same frequency band.

FIG. 19 is another structural diagram of a terminal device according to the present application. As shown in FIG. 19, a terminal device 190 includes:

a processor 191, a memory 192, and an interface 193 communicating with a network device or other terminal devices;

the memory 192 stores computer execution instructions;

the processor 191 executes the computer execution instructions stored in the memory, causing the processor 191 to execute the technical solution of the terminal device side in any one of the above method embodiments.

FIG. 19 is a simple design of the terminal device. The embodiments of the present application do not limit the number of processors and memories in the terminal device. FIG. 19 simply takes the number of 1 as an example for illustration.

In a specific implementation of the terminal device shown in the above FIG. 19, a memory, a processor and an interface can be connected through a bus. In an embodiment, the memory can be integrated inside the processor.

The embodiment of the present application further provides a computer-readable storage medium, where the computer-readable storage medium stores a computer execution instruction, which, when executed by the processor, is used to implement the technical solution of the terminal device in any one of the above method embodiments.

The embodiment of the present application further provides a program, which, when executed by the processor, is used to execute the technical solution of the terminal device in any one of the above method embodiments.

In an embodiment, the above processor may be a chip.

The embodiment of the present application further provides a computer program product, including a program instruction which is used to implement the technical solution of the terminal device in any one of the above method embodiments.

The embodiment of the present application further provides a chip, including a processing module and a communication interface, where the processing module can execute the technical solution of the terminal device side in any one of the above method embodiments.

Further, the chip further includes a storing module (for example a memory), where the storing module is configured to store instructions, the processing module is configured to execute the instructions stored in the storing module, and execution of the instruction stored in the storing module causes the processing module to execute the technical solution of the terminal device side in any one of the above method embodiments.

In several embodiments provided by the present application, it should be understood that the disclosed devices and methods can be implemented in other manners. For example, the device embodiments described above are only schematic. For example, the division of the modules is only a logical function division. In actual implementation, there may be other division methods, for example a plurality of modules can be combined or integrated into another system, or some features can be ignored or not executed. On the other hand, the displayed or discussed mutual coupling or direct coupling or communication connection can be through some interfaces. The indirect coupling or communication connection of the modules may be in electrical, mechanical or other forms.

In a specific implementation of the above terminal device, it should be understood that the processor can be a central processing unit (CPU), other general-purpose processors, digital signal processor (DSP) and application specific integrated circuit (ASIC), etc. A general-purpose processor can be a microprocessor or any conventional processor, etc. The steps in combination with the method disclosed in the present application can be directly embodied as being executed and completed by a hardware processor, or executed and completed by a combination of hardware and software modules in the processor.

All or part of the steps to realize each of the above method embodiments can be completed by hardware related to a program instruction. The program can be stored in a readable memory. The program, when executed, executes steps including each of the above method embodiments. The above memory (storage medium) includes: a read only memory (ROM), an RAM, a flash memory, a hard disk, a solid state disk, a magnetic tape, a floppy disk, an optical disc and any combination thereof

What is claimed is:

1. A sidelink data transmission method, comprising:
determining, by a terminal device, N slots of a first sidelink communication system according to a subcarrier spacing of the first sidelink communication system, wherein N is greater than or equal to 2, a time domain length of the N slots of the first sidelink communication system is as same as a time domain length of one subframe of a second sidelink communication system; and
performing at least one of following operations: transmitting, by the terminal device, first sidelink data of the first sidelink communication system and second sidelink data of the second sidelink communication system within a time duration corresponding to a time domain symbol that is used to transmit the second sidelink data of the second sidelink of the second sidelink communication system within a subframe of the second sidelink; or, not transmitting, by the terminal device, the first sidelink data and the second sidelink data within a time duration corresponding to a time domain symbol that is not used to transmit the second sidelink data of the second sidelink communication system within the subframe.

2. The method according to claim 1, wherein the first sidelink communication system is a new radio (NR) system, and the second sidelink communication system is a long term evolution (LTE) system.

3. The method according to claim 1, wherein a last time domain symbol in each of first N−1 slots of the N slots is mapped with the first sidelink data.

4. The method according to claim 3, wherein the first sidelink data mapped on the last time domain symbol in each of the first N−1 slots comprises at least one of the following:
data carried on a physical sidelink shared channel (PSSCH), a demodulation reference signal (DMRS), a channel state information-reference signal (CSI-RS), a sounding reference signal (SRS) and data randomly generated by the terminal device.

5. The method according to claim 1, wherein last N time domain symbols in Nth slot of the N slots are not used to transmit the first sidelink data.

6. The method according to claim 5, wherein a last time domain symbol in each of the N slots is a guard period (GP) symbol.

7. The method according to claim 6, wherein first N−1 time domain symbols in the last N time domain symbols in the Nth slot of the N slots are mapped with the first sidelink data, and the first sidelink data mapped on the first N−1 time domain symbols are not transmitted by the terminal device.

8. The method according to claim 7, wherein the first sidelink data mapped on the first N−1 time domain symbol comprises data carried on a physical sidelink shared channel (PSSCH).

9. The method according to claim 6, wherein first N−1 time domain symbols in the last N time domain symbols in the Nth slot of the N slots are not mapped with the first sidelink data.

10. The method according to claim 1, wherein the subcarrier spacing of the first sidelink communication system is N times a subcarrier spacing of the second sidelink communication system.

11. The method according to claim 10, wherein a time domain length of one time domain symbol of the second sidelink communication system is equal to a time domain length of N time domain symbols of the first sidelink communication system.

12. The method according to claim 1, wherein the transmitting the second sidelink data of the second sidelink communication system and the first sidelink data of the first sidelink communication system comprises:
transmitting the second sidelink data on a second carrier and transmitting the first sidelink data on a first carrier.

13. The method according to claim 12, wherein the first carrier and the second carrier are different carriers within a same frequency band.

14. A terminal device, comprising:
a processor, a memory and an interface communicating with a network device or other terminal devices;
the memory stores computer execution instructions;
the processor when executing the computer execution instruction, being configured to:
determine N slots of a first sidelink communication system according to a subcarrier spacing of the first sidelink communication system, wherein N is greater than or equal to 2, a time domain length of the N slots of the first sidelink communication system is as same as a time domain length of one subframe of a second sidelink communication system; and
the processor controls the interface to perform at least one of following operations: transmit first sidelink data of the first sidelink communication system and second sidelink data of the second sidelink communication system within a time duration corresponding to a time domain symbol that is used to transmit the second sidelink data of the second sidelink of the second sidelink communication system within a subframe of the second sidelink; or, not transmit the first sidelink data and the second sidelink data within a time duration corresponding to a time domain symbol that is not used to transmit the second sidelink data of the second sidelink communication system within the subframe.

15. The terminal device according to claim 14, wherein the first sidelink communication system is a new radio (NR) system, and the second sidelink communication system is a long term evolution (LTE) system.

16. The terminal device according to claim 14, wherein a last time domain symbol in each of first N−1 slots of the N slots is mapped with the first sidelink data; and
the first sidelink data mapped on the last time domain symbol in each of the first N−1 slots comprises at least one of the following:
data carried on a physical sidelink shared channel (PSSCH), a demodulation reference signal (DMRS), a channel state information-reference signal (CSI-RS), a sounding reference signal (SRS) and data randomly generated by the terminal device.

17. The terminal device according to claim 14, wherein last N time domain symbols in Nth slot of the N slots are not used to transmit the first sidelink data; and
a last time domain symbol in each of the N slots is a guard period (GP) symbol.

18. The terminal device according to claim 17, wherein first N−1 time domain symbols in the last N time domain symbols in the Nth slot of the N slots are mapped with the first sidelink data, and the first sidelink data mapped on the first N−1 time domain symbols are not transmitted by the terminal device; and
the first sidelink data mapped on the first N−1 time domain symbol comprises data carried on a physical sidelink shared channel (PSSCH).

19. The terminal device according to claim 14, wherein when transmitting the second sidelink data of the second sidelink communication system and the first sidelink data of the first sidelink communication system, the processor controls the interface to:
transmit the second sidelink data on a second carrier and transmit the first sidelink data on a first carrier.

20. A non-transitory computer-readable storage medium, wherein the non-transitory computer-readable storage medium stores computer execution instructions, which, when executed by the processor, are configured to implement the sidelink data transmission method according to claim 1.
